(19) United States
(12) Patent Application Publication
(10) Pub. No.: US 2012/0317442 A1
(43) Pub. Date: Dec. 13, 2012

(54) EMBEDDED DEVICE AND EMBEDDED SYSTEM

(75) Inventors: Takehiko Nagano, Tokyo (JP); Junichi Kimura, Koganei (JP)

(73) Assignee: HITACHI, LTD., Tokyo (JP)

(21) Appl. No.: 13/516,526

(22) PCT Filed: Jan. 12, 2011
(86) PCT No.: PCT/JP2011/050354

§ 371 Date: Aug. 20, 2012

(30) Foreign Application Priority Data
Jan. 15, 2010 (JP) 2010-007052

(51) Int. Cl. G06F 11/07

(52) U.S. Cl. 714/37; 714/E11.029

(57) ABSTRACT

The redundancy that is effected by preparing a plurality of units of hardware of an identical configuration results in high costs, complicating the application of same to inexpensive products. The present invention detects a fault in a function that is provided via hardware upon an apparatus having a variety of components, such as a CPU, capable of changing content to be processed at the application level, and an FPGA, capable of changing the content to be processed. When a fault is thus detected, the invention uses configuration information of an apparatus either within the apparatus or within apparatuses upon the network to select an apparatus capable of serving as a substitute, selects software required to implement the function, carries out procedures for facilitating the use of the software upon the substitute hardware (i.e., downloading the software, loading the software into a memory region accessible to the hardware), and carries out the processing in substitution.

### TECHNICAL FIELD

The present invention relates to an embedded device including a CPU or an electronic device similar to the CPU and an embedded system where a part of functions of the embedded device is arranged in a network. More particularly, the present invention relates to an embedded device and an embedded system suitable for a consumer electronics product.

### BACKGROUND ART

Conventionally, in a processing system using a computer, a redundant system is employed to prevent a reduction of availability due to system failure. For example, Patent document 1 discloses a system that reconstructs a combination of hardware and software in a network constructed with a plurality of redundant system. The redundant system includes multiplexed hardware units where the same processing function is assigned to a plurality of units. Even when failures are occurred and some portion fails, another portion continues the operation. This allows the whole system to continue the operation.

### PRIOR ART DOCUMENTS

### Patent document

Patent document 1: Japanese Patent Application Laid-Open Publication No. 2005-251055

### SUMMARY OF THE INVENTION

### Problem to be solved by the Invention

In a conventional redundant method, the redundancy of hardware with a function generally requires an additional hardware unit that has the same function.

In contrast, a development of an embedded device typified by consumer electronics including a CPU or a similar electronic device faces severe cost competition. This puts importance on reduction in production cost and makes it difficult to provide a plurality of hardware units with the same configuration, similarly to the conventional redundancy scheme. It has been difficult to develop a system product with redundant configuration. However, from the aspect of a user, if a part of hardware unit of an electronic device fails and ends up with the disabled product, the user has to repurchase the product or replace with the expensive whole component or substrate. This leads to excessive loss in cost and time period. The failed function includes a considerably important function and a function of less importance for the user. Accordingly, from the standpoint of a user, if a given embedded unit fails, the user needs to continue using the embedded unit insofar as the important function is maintained even if another function deteriorates a little bit without immediately repurchasing and replacing the product.

A problem addressed by the present invention is to provide an embedded device and an embedded system with high availability at low cost by reducing in cost caused by the increased number of components.

Another technical problem addressed by the present invention is to provide an embedded device and an embedded system that performs a fall back operation according to the user needs.

### Means for Solving Problem

A typical example of the present invention will be described as follows. An embedded device of the present invention includes: a plurality of hardware units, each of the hardware units achieving respective specific function; a storage device; and a failure diagnosis device configured to monitor functions of the respective hardware units, the failure diagnosis device executing an alternative process of a function when the hardware unit fails. The plurality of hardware units include: at least one dedicated hardware unit configured to function a specific function; and at least one CPU configured to change a content of processing at application level. The storage device stores: a rule definition file that defines one of the other hardware units when a failure is detected as an alternative processor of a function for the hardware unit where the failure is detected; and a software group that is used to execute the alternative process of the function with the other hardware unit. The failure diagnosis device is configured to select the other hardware unit that alternatively performs the function of the hardware unit and the software required for the alternative process of the function by the other hardware unit based on the rule definition file and the software group if the failure of the function of one of the hardware units is detected.

### Effects of the Invention

In the present invention, if the failed hardware unit is detected in the embedded device, another hardware unit such as the dedicated hardware unit, a CPU, and a rewritable FPGA is used to achieve an alternative function of the failed hardware unit. This ensures redundancy without adding any extra device, thus promising cost reduction.

If the function of the failed hardware unit is considerably important for a user, a function that is not necessary for the user among usually prepared functions is degraded. Then the system is changed such that the system continues to perform the failed function, thus executing fall back of the embedded device operation considering user needs.

### BRIEF DESCRIPTION OF THE DRAWINGS

FIG. 1 is a block diagram illustrating an exemplary general configuration of a digital television receiver with functions of recording and playback according to a first embodiment of the present invention.

FIG. 2 is a table illustrating a main function (application), an original specification (characteristic), an exemplary configuration device and software program, and an alternative function (application) of respective hardware units according to the first embodiment.

FIG. 3 is a table illustrating an exemplary rule definition file according to the first embodiment.

FIG. 4 is a block diagram illustrating an exemplary configuration of a failure diagnosis device.

FIG. 5 is a flowchart illustrating an exemplary processing sequence of the failure diagnosis device.

FIG. 6 is a table illustrating an exemplary alternate status table.

FIG. 7 is a flowchart illustrating an exemplary alternative software program determining process sequence.

FIG. 8 is a block diagram illustrating an exemplary general configuration of a mobile phone according to a second embodiment of the present invention.

FIG. 9 is a table illustrating a main function, an original specification, an exemplary configuration device and software program, and an alternative function of respective hardware units according to the second embodiment.

FIG. 10 is a table illustrating an exemplary rule definition file according to the second embodiment.

FIG. 11 is a block diagram illustrating an exemplary general configuration according to a fourth embodiment of the present invention.

FIG. 12 is a block diagram illustrating an exemplary general configuration according to a fifth embodiment of the present invention.

### MODE FOR CARRYING OUT THE INVENTION

The present invention achieves a redundant function implemented in a hardware unit not using the same hardware unit, but using a different hardware unit constituting a system. This reduces an increase in cost caused by the increased number of components and provides an embedded device with high availability at low price. That is, if the present invention detects a failure of function implemented in a hardware unit on a device that includes a CPU (including multiple cores), which can change a content of processing at application level, or an FPGA and the like, which can change a content of processing, the present invention refers to device configuration information on the device or on a network. The present invention then selects an alternative device and a software program required for achieving the function. The present invention executes a procedure (for example, downloading software program and deploying it in a memory region to be accessed by a hardware unit) to allow the alternative hardware unit to use the software program, thus alternatively performing the processing.

### FIRST EMBODIMENT

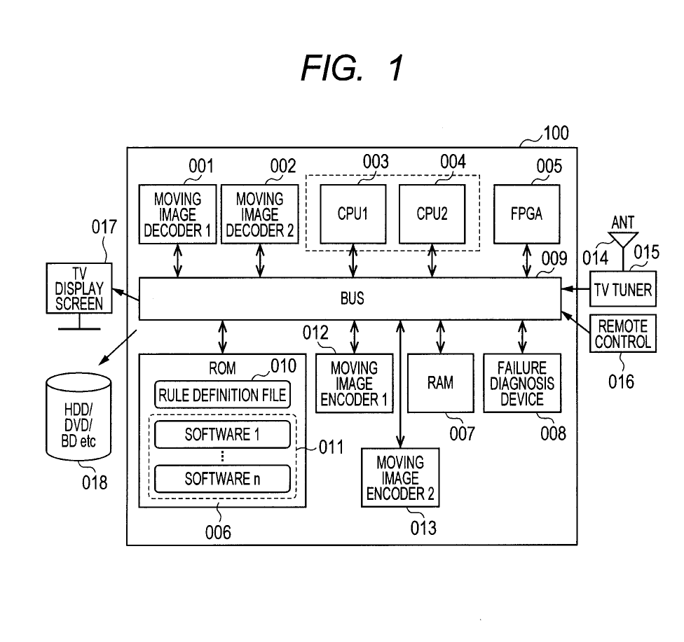

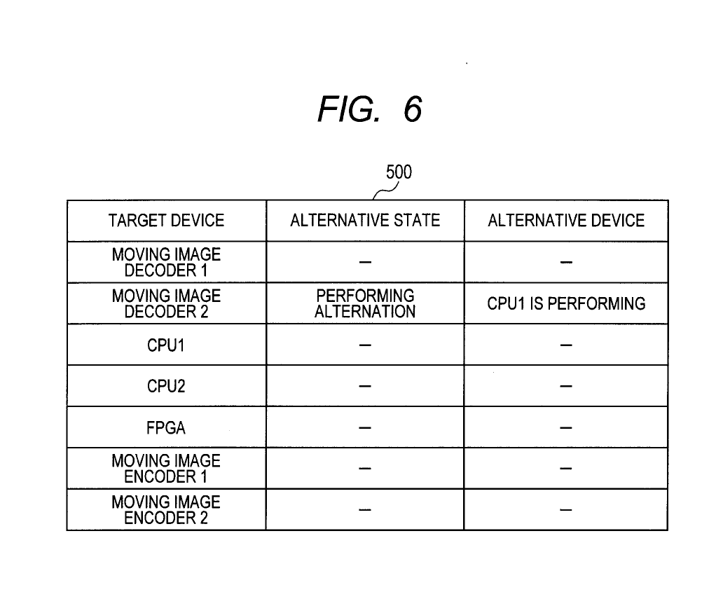

First, a first embodiment where an embedded device of the present invention applied to a digital television receiver with functions of recording and playback will be described. FIG. 1 is an explanatory view illustrating an exemplary digital television receiver employing the embedded device of the present invention. In FIG. 1, an embedded device, that is, a main body 100 of the digital television receiver includes hardware units 001 to 005, 012, and 013, which achieve functions, a ROM 006, which includes software program that achieves functions, a RAM 007 used for respective processings, a failure diagnosis device 008, and a bus 009. The failure diagnosis device 008 monitors hardware units 001 to 005, 012, and 013, which achieve functions, and detects failure of the hardware unit. The bus 009 couples the above-described respective devices 001 to 008 together to exchange data. As a hardware unit, the main body 100 includes a first moving image decoder 001 and a second moving image decoder 002 as dedicated hardware units, a first CPU 003 and a second CPU 004, which can change a content of processing at application level, and an FPGA 005, which changes a content of processing. Further, the main body 100 includes a first moving image encoder 012 and a second moving image encoder 013 as dedicated hardware units. The ROM 006 stores a rule definition file 010 and a software group 011. The rule definition file 010 defines an alternative means of a function where a failure has been detected. The software group 011 is constituted of software programs, configuration information and the like to be used when an alternative process of the failure-detected function is executed by another hardware unit. Here, the RAM 007 is a memory shared by respective devices in the main body 100 of the digital television receiver. The RAM 007 temporarily records respective bits of information at processings such as data communication, recording and selecting of a program, and recording and playback. The RAM 007 also stores an alternate status table (see FIG. 6), which is used at diagnosis by the failure diagnosis device 008. The failure includes not only a physical functional failure of a hardware unit itself but also a functional failure of software program that integrally performs on the hardware unit. A function deteriorated below a predetermined level may also be diagnosed as a failure.

The main body 100 of the digital television receiver receives, for example, TV broadcast wave through an antenna 014, a tuner 015 and the like, and receives operation input of a user through a remote control 016. Received data of TV broadcast is displayed on a television display screen 017, recorded in an external memory 018, or played back and displayed after recording by, for example, program selection from a user.

In the main body 100 of the digital television receiver in this embodiment, the first moving image decoder 001 and the second moving image decoder 002 are dedicated hardware units that each execute a specific processing only. The first CPU 003 and the second CPU 004 each execute a processing corresponding to an embedded software program, in other words, the first CPU 003 and the second CPU 004 are hardware units to execute a general-purpose processing. The FPGA 005 is a dedicated hardware unit to execute a specific processing and is allowed to change a content of processing afterward. The failure diagnosis device 008 regularly transmits a signal to respective hardware units 001 to 005, 012 and 013 through the bus 009, and determines whether the devices fail based on replied information. In the case where a determination result is returned as failure, the failure diagnosis device 008 selects an appropriate software program from the software group 011 stored in the ROM 006 based on the rule definition file 010 stored in the ROM 006. The failure diagnosis device 008 executes a procedure to start a processing of software program that executes an alternative process on a defined hardware unit.

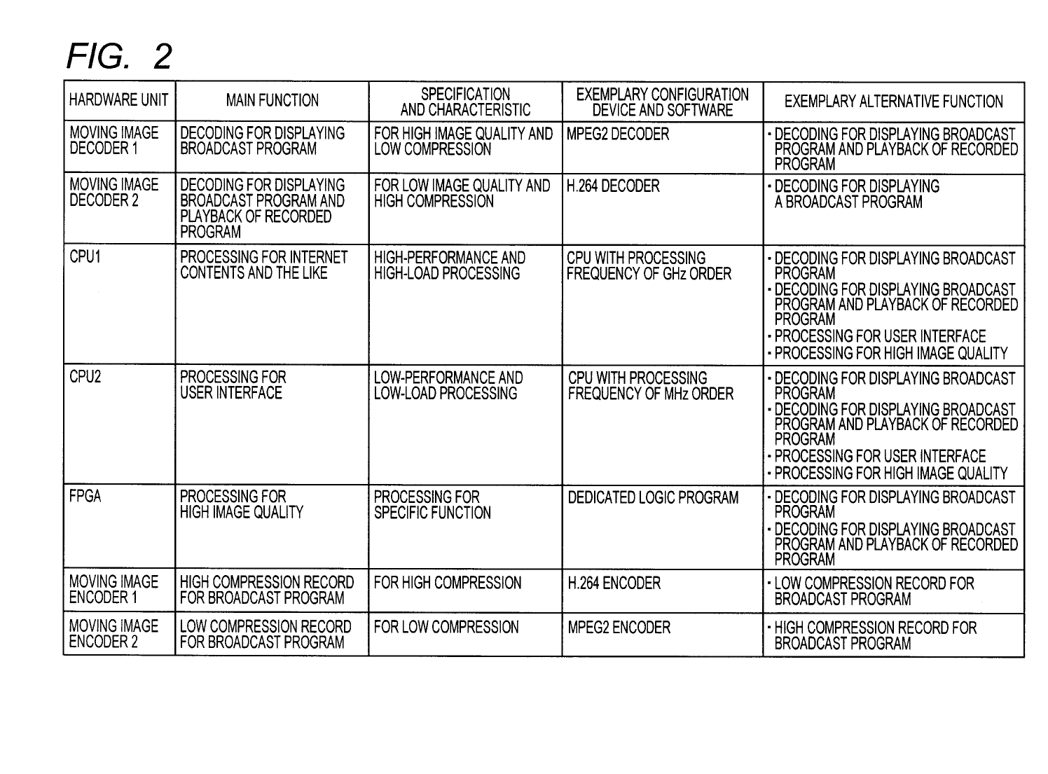

FIG. 2 illustrates a main function (application), an original specification (characteristic), an exemplary configuration device and software program, and an alternative function (application) of respective hardware units 001 to 005, 012, and 013. The first moving image decoder 001 has a main function of decoding for displaying a broadcast program. The first moving image decoder 001 includes a device with specification for high image quality and low compression. Specifically, this specification is MPEG2 for example. The second moving image decoder 002 has a main function of displaying a broadcast program and decoding for playback of a recorded program. The second moving image decoder 002 includes a device with specification for low image quality and high compression ratio. Specifically, this specification is H264 or jpeg for example. The first CPU 003 and the second CPU 004 are general-purpose CPUs. Here, the first CPU 003 has a main function of a processing of Internet contents for example. The first CPU 003 employs a CPU, which is expensive though, with a specification for high performance and high-load processing. For example, a CPU of Pentium (registered trademark) series fabricated by Intel Corporation with a processing frequency of GHz order is used. On the other hand, the second CPU 004 has a main function of a processing for user interface typified by displaying, for example, a program guide. Thus, as requested specification, processing capacity may comparatively be low. The second CPU 004 employs a low-price CPU such as a CPU of SH-Mobile (registered trademark) series fabricated by Renesas Electronics Corporation with a processing frequency of MHz order. The FPGA 005 has a main function of processing for high image quality, and constituted of a dedicated logic program. The processing capacity is not so high compared with the first CPU 003. The first moving image encoder 012 has a main function of high compression recording for a broadcast program, and employs a CPU with specification for high compression ratio. The second moving image encoder 013 has a main function of low compression record for a broadcast program, and employs a CPU with specification for low compression ratio.

Thus, the hardware units are each different in main function (application) and specification (characteristic) and also include some alternative functions. For example, the first moving image decoder 001 and the second moving image decoder 002 are different in specification, but are mutually alternative. Functions of the first moving image decoder 001 and the second moving image decoder 002 become alternative to the first CPU 003 or the second CPU 004 by embedding each predetermined program in the first CPU 003 or the second CPU 004. Functions of the first moving image decoder 001 and the second moving image decoder 002 also become alternative to the FPGA 005 by rewriting a logic program of the FPGA 005. The first CPU 003 and the second CPU 004 are different in specification, but are mutually alternative. The first moving image encoder 012 and the second moving image encoder 013 are different in specification, but are mutually alternative to each other.

Type, number, and specification of hardware devices illustrated in FIG. 1 and FIG. 2 are only examples, and may be conveniently changed corresponding to, for example, functions and cost required for television.

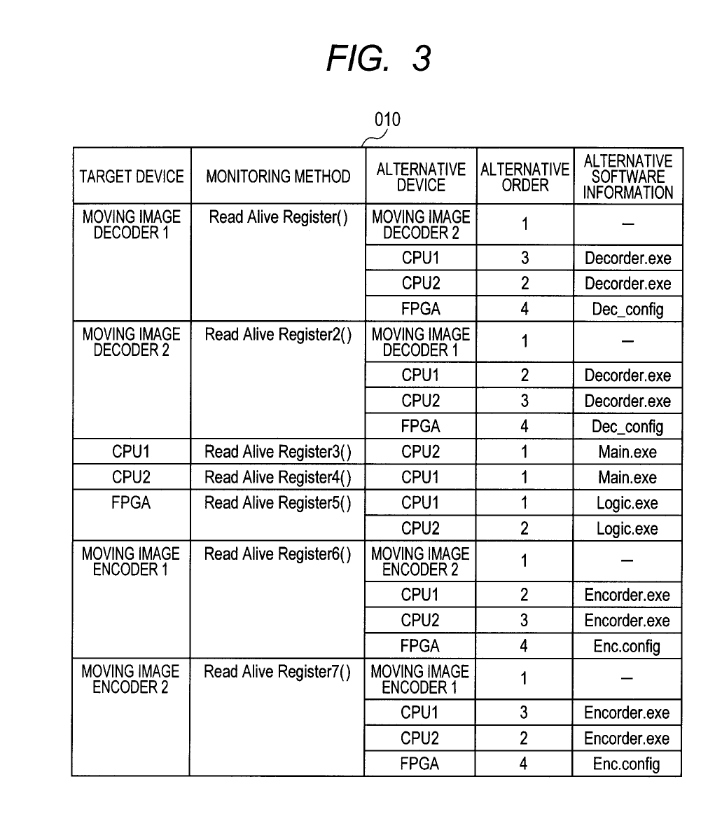

FIG. 3 is an explanatory view illustrating an exemplary rule definition file 010 stored in the ROM 006. This includes attribution such as a target device, a monitoring method, an alternative device, an alternative order, alternative software information and the like. As target devices, names of hardware units that implement respective functions constituting the main body of a high-reliability system as a target are registered. The high-reliability system is a digital television receiver with functions of recording and playback. As monitoring methods, means that identifies the above hardware unit and an interface such as Read Alive Register ( ) are registered. The interface calls the means to execute. As alternative devices, names of hardware units that are alternatively able to perform or alternatively desired to perform the function of the target device are registered. As the alternative orders, following contents are registered for the respective target devices. The content shows hardware units to preferentially alternate among the hardware unit registered in the column of the alternative device when the target device fails. As the alternative software information, information of software programs that are to be executed on the alternative device for alternation at alternation of the function are registered. The information is used to execute on the hardware unit specified as the alternative device among the alternative devices at the control of the failure diagnosis device 008. For example, in the case where a function of the first moving image decoder 001 is alternatively performed by the first CPU 003, an MPEG2-compliant software program is used on the CPU and then executes decoding a moving image.

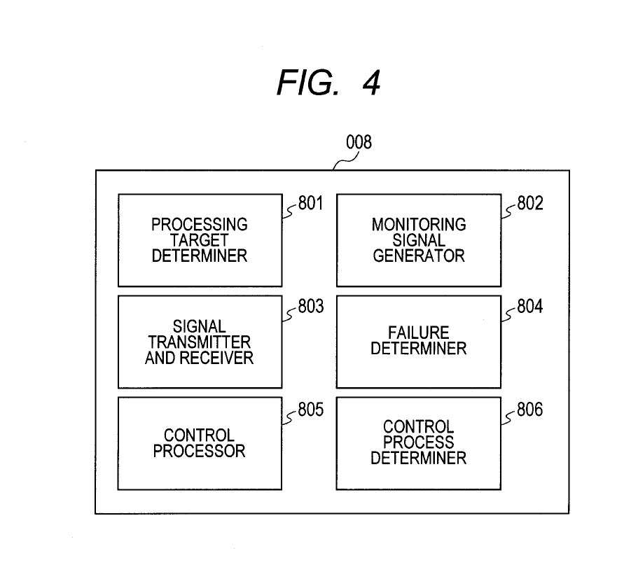

FIG. 4 is a diagram illustrating an exemplary detailed configuration of the failure diagnosis device 008 in FIG. 1. The failure diagnosis device includes a processing target determiner 801, a monitoring signal generator 802, a signal transmitter and receiver 803, and a failure determiner 804. The processing target determiner 801 determines a target to monitor among hardware units that achieve function of a system to be the target. The monitoring signal generator 802 generates a monitoring signal required for executing query corresponding to the monitoring target after determining the monitoring target. The signal transmitter and receiver 803 transmits the monitoring signal to the monitoring target hardware unit and receives a result of monitoring. The monitoring signal is generated by the monitoring signal generator 802 to execute monitoring on the monitoring target hardware unit. The failure determiner 804 analyzes the monitoring result received by the signal transmitter and receiver 803, and determines whether a failure has occurred. Further, the failure diagnosis device 008 includes a control processor 805 and a control process determiner 806. If the determination result by the failure determiner 804 is failure, the control processor 805 reads out the rule definition file 010 in the ROM 006. The control processor 805 selects an alternative device with a high alternative order among the alternative devices to achieve the failed function of the hardware unit. The control processor 805 executes associating a name of a software program required for the alternation. The control processor 805 executes an alternative software program on the alternative device. The control process determiner 806 determines whether a control processing is accurately terminated based on a processing result of the alternative software program executed by the control processor 805. The control process determiner 806 also determines whether to execute a procedure of an alternative process for a subsequently corresponding failed device with another alternative device or to return to the processing for monitoring.

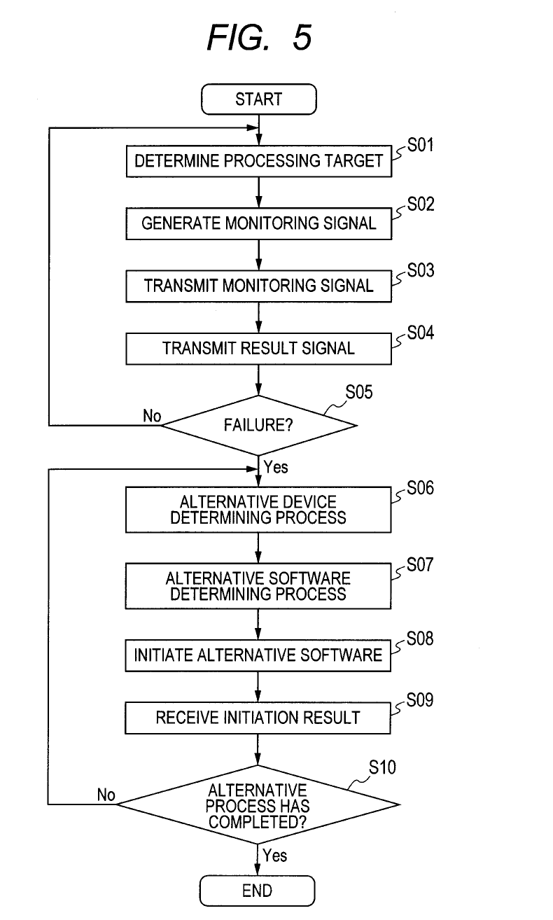

The failure diagnosis device 008 regularly transmits a signal to respective hardware units 001 to 005, 012, and 013 through the bus 009 for failure diagnosis. The failure diagnosis device 008 determines whether the respective devices fail based on replied information. FIG. 5 is a flowchart illustrating one processing sequence of the failure diagnosis device. The timer is used for regular initiation to start processing. After the processing started, the process proceeds to step S01 to determine a processing target using the rule definition file 010. After determining the processing target, the process proceeds to step S02 to generate a monitoring signal using the rule definition file 010. The process proceeds to step S03. In step S03, the monitoring signal associated in step S02 is transmitted to the monitoring target. The process proceeds to step S04. In step S04, the result signal replied from the monitoring target is received. The process proceeds to step S05. In step S05, the result signal received in step S04 is analyzed to determine the result signal indicates failure or normal. If the result signal indicates normal, the process returns to step S01, thus proceeding to the next process.

If the result signal indicates failure, the process proceeds to step S06. In step S06, the rule definition file 010 is used to determine an alternative device among alternative devices for the device as the failure diagnosis target based on the alternative order. The process proceeds to step S07. In step S07, an alternative software program is determined based on the monitoring target device information and the alternative device information determined in step S06. The process proceeds to step S08. In step S08, a processing is executed to initiate the alternative software program on the alternative device based on the alternative device information determined in step S06 and the alternative software information determined in step S07. The process proceeds to step S09. In step S09, the processing result of the alternative software program executed in step S08 is received. The process proceeds to step S10. In step S10, it is determined whether the initiation of the alternative process has been completed based on the initiation result of the alternative software program received in step S09. If the initiation has been completed, the processing terminates. If the initiation of the alternative process has not been completed, the process returns to step S06, thus retrying the processing from the selection of an alternative device.

A processing for associating a monitoring signal in step S02 may not be a type of processing for transmitting a preliminarily registered monitoring signal, and may be a type of processing for generating a monitoring signal using information of, for example, a target device.

FIG. 6 is a diagram illustrating an exemplary alternate status table 500 that indicates an alternate status management state in a system. The alternate status table 500 has attribution of a target device, an alternative state, and an alternative device. The target device indicates a list of redundant targets. The alternative state indicates a state of alternation performed by the target device. The alternative device indicates a device to alternately perform if the target device is alternately performed. An example in FIG. 6 illustrates a function of the second moving image decoder 002 alternately performed by the first CPU 003. In view of this, the first CPU 003 time-divisionally executes a function to process recording and playback of a broadcast program in addition to a processing of, for example, Internet contents, which is an original function. Information indicating that the alternation is being executed due to partial failure of the target device is provided to a user by a method of, for example, displaying on a TV display screen.

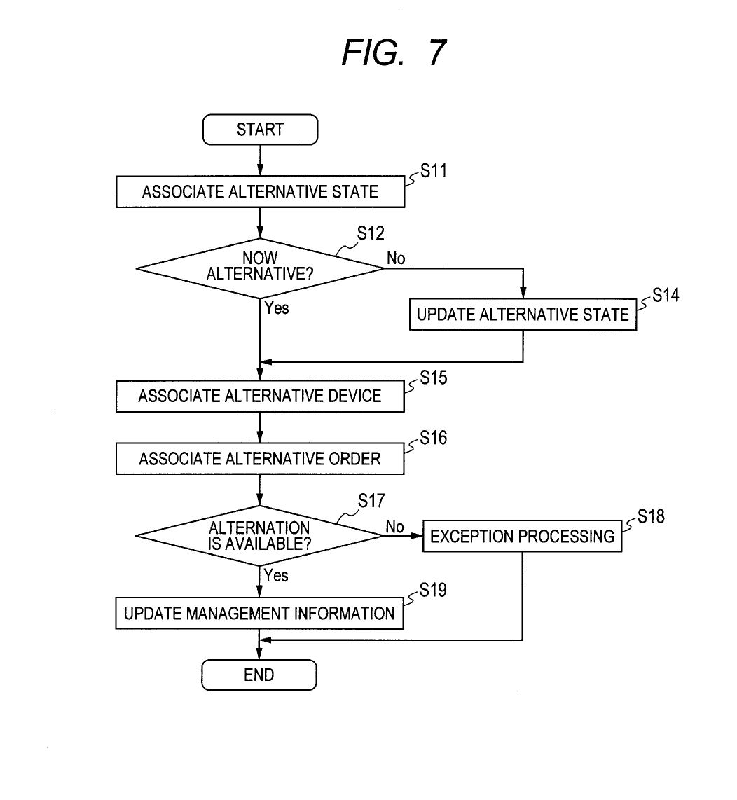

FIG. 7 is a flowchart illustrating a detail of an alternative software program determining process S07. After processing starts, the process proceeds to step S11 to use the alternate status table 500 illustrated in FIG. 6, thus associating an alternative state of a current monitoring target. The process proceeds to step S12. In step S12, a result of step S11 is received to determine whether the current monitoring target is an alternative device. If the current monitoring target is alternately performed, the process proceeds to step S15. If the current monitoring target is not alternately performed, the process proceeds to step S14. In step S14, alternative state attribution of the target device, which is the current monitoring target, is changed to during the alternation. The process proceeds to step S15. In step S15, an alternative device name of the current target device is associated using the alternate status table. The process proceeds to step S16. In step S16, a current alternative order is associated using the alternative device information associated in step S15 as a key. The process proceeds to step S17. In step S17, a next alternative device is searched using the alternative order associated in step S16 as a key and using entries of an alternative order in the rule definition file 010. If an alternation is possible, the process proceeds to step S19. If an alternation is not possible, the process proceeds to step S18. In step S18, an exception processing is executed to notify the user that no more alternative process is possible. Then the processing terminates. In step S19, the alternative device name in the alternate status table is updated. Then the processing terminates.

In the embodiment, for example, if the second moving image decoder 002 fails, a function to be provided by the second moving image decoder 002 is alternatively performed by the first moving image decoder 001 or the first CPU 003 or the like, which has a similar decoding function. At this time, a device such as the first moving image decoder 001 or the first CPU 003, which is in charge of the alternative function, time-divisionally provides both of a function originally provided by the device and the alternative function. Accordingly, performance of, for example, processing speed or image quality is slightly decreased during the alternation. On the other hand, the digital television receiver with functions of recording and playback nearly maintains its functions as a whole.

The ROM 006 illustrated in FIG. 1 is configured to store data, which may change into every device for which a general-purpose or dedicated CPU is available.

The failure diagnosis device 008 illustrated in FIG. 1 may be constituted of hardware units or a combination of software and hardware. The failure diagnosis device 008 may not be an independent device and may be constituted of one software program or a plurality of software programs implemented in a general-purpose CPU.

Thus, with the embodiment, in a digital television receiver with functions of recording and playback including a CPU, which changes a content of processing at application level, an FPGA, which changes a content of processing, and the like, if the failure diagnosis device detects a function failure implemented in a hardware unit, an alternative device and a software program required to achieve the function are selected referring to configuration information on the device or on a device in a network. Then the embodiment executes a procedure (for example, downloading software program and deploying it in a memory region accessed by a hardware unit) to allow an alternative hardware unit to use the software program, thus alternatively performing the processing. This ensures alternation of, for example, functions of receiving and displaying a program, which are main functions of a television receiver without implementing an extra hardware unit to achieve the same function. Thus, this reduces an increase in cost caused by an increased number of components and provides a digital television receiver with functions of recording and playback at low price with high availability. For a user, important functions are maintained even if a part of the device fails. This allows the user to continue using the digital television receiver for a time without immediate repurchase or replacement of the part.

### Second Embodiment

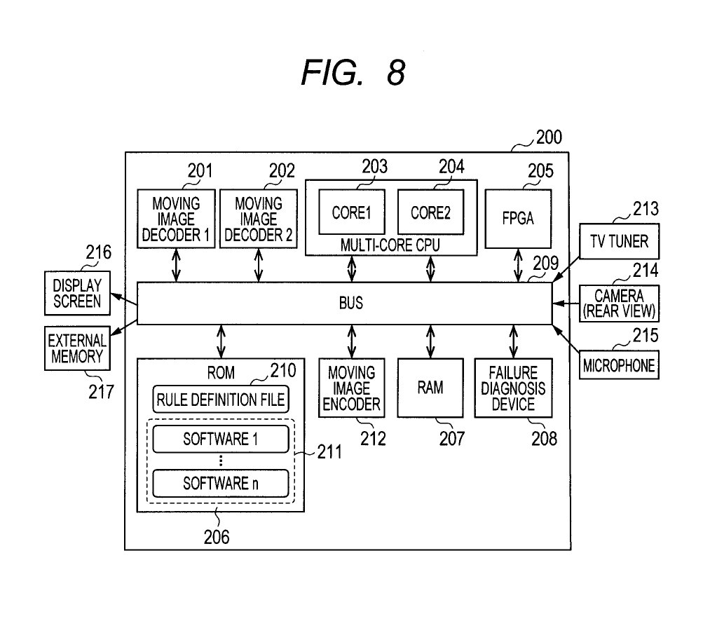

Next, a second embodiment where an embedded device of the present invention is applied to a mobile phone will be described. FIG. 8 is an explanatory view illustrating an exemplary configuration of an embedded device according to the present invention, that is, a mobile phone. In FIG. 8, a main body 200 of the mobile phone includes hardware units 201 to 205, and 212 to achieve functions, a ROM 206, a RAM 207, a failure diagnosis device 208, and a bus 209. The ROM 206 includes software programs to achieve functions. The RAM 207 is used for respective processings. The failure diagnosis device 208 monitors the hardware units 201 to 205, and 212 that achieve functions to detect failure of the respective hardware units, and executes an alternative process. The bus 209 couples the above-described respective devices 201 to 208, and 212 to exchange data. As the hardware units, the main body 200 includes a first moving image decoder 201, a second moving image decoder 202, a first core 203, a second core 204, and an FPGA 205. The first core 203 and the second core 204 constitute multiple cores. The main body 200 further includes a moving image encoder 212. The ROM 206 stores a rule definition file 210 and a software group 211. The rule definition file 210 defines an alternative unit of a function where a failure has been detected. The software group 211 is constituted of software programs, configuration, and the like to be used when an alternative process of the failure-detected function is executed by another hardware unit. Here, the RAM 207 is a memory shared by respective devices in the main body 200 of the mobile phone. The RAM 207 temporarily records respective bits of information at processings such as recording and playback of transmitted and received data of a phone call, mail, Internet, and One Seg and recording and playback of data including multimedia data through, for example, a numerical keypad (not shown), a camera, and a microphone. An alternate status table (see FIG. 6) that is used at diagnosis by the failure diagnosis device 208 is also stored in the RAM 207. Instead of the multiple cores, a multi-CPU system described in the first embodiment may be used. Conversely, the multi-CPU system described in the first embodiment may be replaced with multiple cores.

The main body 200 of the mobile phone receives radio wave of, for example, telephone, mail, web site, and One Seg through an antenna 213 or the like, and receives operation input of a user through a numerical keypad (not shown), an image through the camera 214, and a sound voice input through the microphone 215. Received signal-processed information is displayed on a display screen 216, recorded in an external memory 217, or displayed after recording and playback by a selection instruction from a user. Transmission information of, for example, telephone mail is transmitted from the antenna 213 after signal processing is executed on the transmission information of telephone, email or the like.

In the main body 200 of the mobile phone of the embodiment, the first moving image decoder 201 and the second moving image decoder 202 are dedicated hardware units that each execute a specific processing only. The first core and the second core 204 each execute a processing corresponding to respective embedded software programs, in other words, the first core 203 and the second core 204 are hardware units to execute a general-purpose processing. The FPGA 205 is a dedicated hardware unit to execute a specific processing and is allowed to change a content of processing afterward. The failure diagnosis device 208 regularly transmits a signal to respective hardware units 201 to 205, and 212 through the bus 209, and determines whether the respective devices fail based on replied information. If the determination result is returned as failure, the failure diagnosis device 208 selects an appropriate software program from the software group 211 stored in the ROM 206 based on the rule definition file 210 stored in the ROM 006, and executes procedure to start a processing of a software program that executes an alternative process on a defined hardware unit.

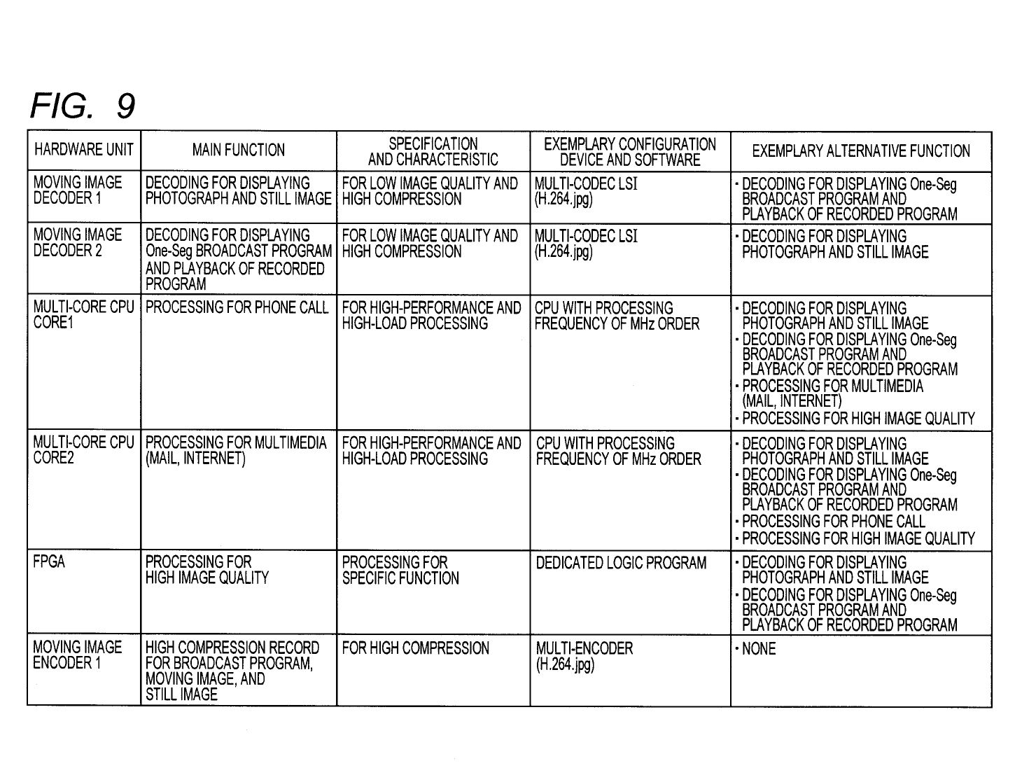

FIG. 9 illustrates a main function (application), an original specification (ability and performance), an exemplary specific configuration device and software, and an alternative function (application) of respective hardware units 201 to 205, and 212 that constitute a main body of a mobile phone. The first moving image decoder 201 has a main function of decoding for displaying a photograph and a still image. The first moving image decoder 201 is for use in a mobile phone and has a specification for low image quality and high compression ratio. Specifically, JPEG is used for example. The second moving image decoder 202 performs decoding for displaying and playback of a recorded program of a One-Seg broadcast program for example. The second moving image decoder 202 is for a mobile phone and has a specification for low image quality and high compression ratio. Specifically, H264 is used for example. Core 1 in multiple cores has a main function of processing for phone calls, and uses software program 1 to execute a high speed and high performance processing. Specifically, signal processing for CDMA is executed.

Core 2 in multiple cores has a main function of processing relating to multimedia, mail, and Internet. Thus, as the specification, processing capacity and performance may be comparatively low or low-price. Specifically, core 2 executes communication processing (for example, TCP/IP protocol processing) of Internet.

The FPGA 205 performs processing for improving image quality of respective moving image and still image contents, and is constituted of a dedicated logic program. Thus, the FPGA 205 has low performance at low price compared with a general-purpose CPU.

The moving image encoder 212 has main functions of compressing and recording for data of, for example, a broadcast program, a moving image, and a still image. Thus, as the specification, the moving image encoder 212 is necessary to be a high compression multi-encoder that supports a plurality of standards.

In view of this, a plurality of hardware units that constitute a mobile phone are different in main function, but also include some alternative functions.

For example, the first moving image decoder 201 and the second moving image decoder 202 are different in specification, but are mutually alternative in function. Functions of the first moving image decoder 201 and the second moving image decoder 202 become alternative to the first core 203 or the second core 204 by embedding each predetermined program in the first core 203 or the second core 204. Functions of the first moving image decoder 201 and the second moving image decoder 202 also become alternative to the FPGA 205 by rewriting a logic program of the FPGA 205. The first core 203 and the second core 204 are different in specification, but are mutually alternative. Functions of the moving image decoder 212 become alternative to the first core 203 or the second core 204 by embedding a predetermined program in the first core 203 or the second core 204.

Functions of the moving image decoder 212 also become alternative to the FPGA 205 by rewriting a logic program of the FPGA 205.

For example, kind of hardware devices, the number and specification of those illustrated in FIG. 8 and FIG. 9 are only examples, and may be conveniently changed corresponding to, for example, functions and cost required for a mobile phone.

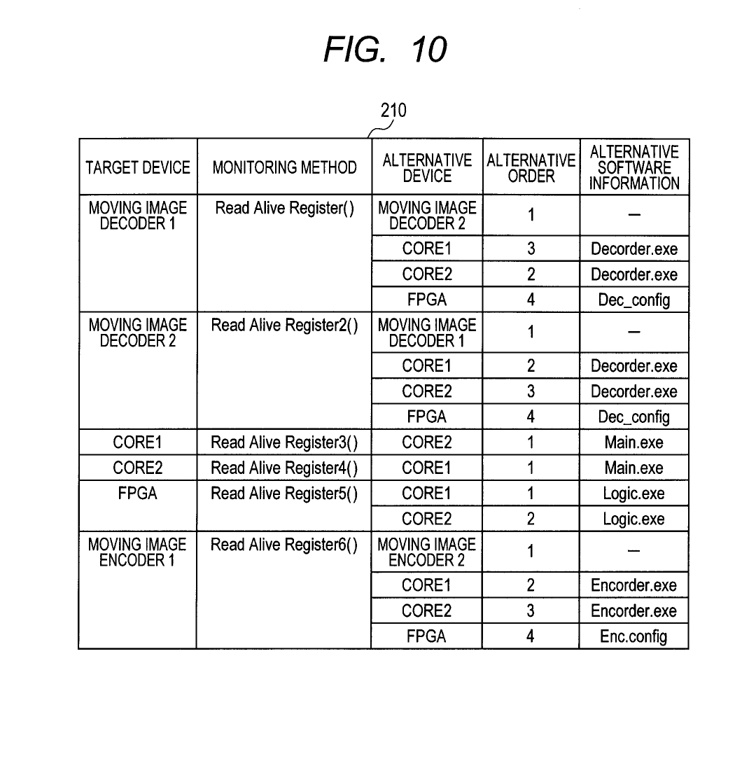

FIG. 10 is an explanatory view illustrating an exemplary rule definition file 210 stored in the ROM 206. The rule definition file 210 includes attribution such as a target device, a monitoring method, an alternative device, an alternative order, and alternative software information. As the target device, names of hardware units that achieve respective functions constituting the main body of the mobile phone are registered. As the monitoring method, means that determines the above hardware unit and an interface to call the means and to execute are described. As the alternative device, names of hardware units that are alternatively able to perform or alternatively desired to perform the function of the target device are registered. As the alternative order, following contents are registered for the respective target devices. The content shows hardware units to preferentially alternate among the hardware units registered in the column of the alternative device when the target device fails. As the alternative software information, information of software programs that are to be executed on the alternative device for alternation at alternation of a function are registered.

The failure diagnosis device 208 regularly transmits a signal to respective hardware units 201 to 205, and 212 through the bus 209 for failure diagnosis. The failure diagnosis device 208 determines whether the respective devices fail based on replied information. A processing sequence of the failure diagnosis device is similar to that illustrated in FIG. 5. If a failure is detected, the rule definition file 210 is used to determine an alternative device and an alternative software program among alternative devices for the device as the failure diagnosis target based on the alternative order. A processing for initiating the alternative software program is then executed on the alternative device. Then, when a processing result of the executed alternative software program is received and the initiation is completed, the processing terminates. If the initiation of the alternative process has not completed, the processing retries execution from the selection of an alternative device.

In the embodiment, for example, devices such as the first moving image decoder 201 and the first core 203, which is in charge of the alternative function, also provide both of a function that those devices originally provide and an alternative function. Accordingly, performance of, for example, processing speed or image quality is slightly decreased during the alternation. On the other hand, the mobile phone nearly maintains its functions as a whole.

The ROM 206 is configured to store data, which may change into every device for which a general-purpose or dedicated CPU or the like is available. The failure diagnosis device 208 may be constituted of hardware units or a combination of software and hardware. The failure diagnosis device 208 may not be an independent device and may be constituted of one software program or a plurality of software programs implemented in a general-purpose CPU.

Thus, with the embodiment, in a mobile phone including another device, which has the similar function such as a moving image decoder, a multiple cores or multi-CPU, which can change a content of processing at application level, or an FPGA, which changes a content of processing, if the failure diagnosis device detects a function failure implemented in a hardware unit, an alternative device and a software program required to achieve the function are selected referring to configuration information on the device or on a device in a network. Then the embodiment executes a procedure (for example, downloading a software program and deploying it in a memory region accessed by a hardware unit) to allow an alternative hardware unit to use the software, thus alternatively performing the processing. This ensures alternation of, for example, a function of phone call, which is a main function of a mobile phone without implementing an extra hardware unit to achieve the same function. Thus, this reduces an increase in cost caused by an increased number of components and provides a mobile phone at low price with high availability. For a user, important functions are maintained even if a part of the device fails. This allows the user to continue using the mobile phone for a time without immediate repurchase or replacement of the part.

### Third Embodiment

An embedded device of the present invention may also be applied to a car navigation device including a CPU or an electronic device similar to the CPU. A car navigation device generally provides information as services relating to multimedia, mail, Internet in addition to an original navigation function. Accordingly, the car navigation device is achieved by embedding a software program and a failure diagnosis device, which are similar to those described above, in an embedded device with a hardware unit, which is similar to those described in the first embodiment and the second embodiment. A configuration of the rule definition file is similar to those illustrated in FIG. 3 or FIG. 10. However, in the case of the car navigation device, safety driving of car is top priority. Thus an alternative order of the rule definition file is set such that maintaining the navigation function is top priority. For example, if the first moving image decoder with the navigation function as its main function fails, the CPU or the core corresponding to music and phone call as their main functions performs an alternative of the first moving image decoder, thus maintaining the navigation function.

In the embodiment, use of another device that has a similar function, a CPU, multiple cores, or an FPGA which is rewritable, ensures redundancy without adding any extra device, thus promising cost reduction. If the failed function is the navigation function, which is considerably important for a user, a function that is not necessary for the user among usually prepared functions is degraded. Then the system is changed such that the navigation function continues to perform, thus executing fall back operation considering user needs.

### Fourth Embodiment

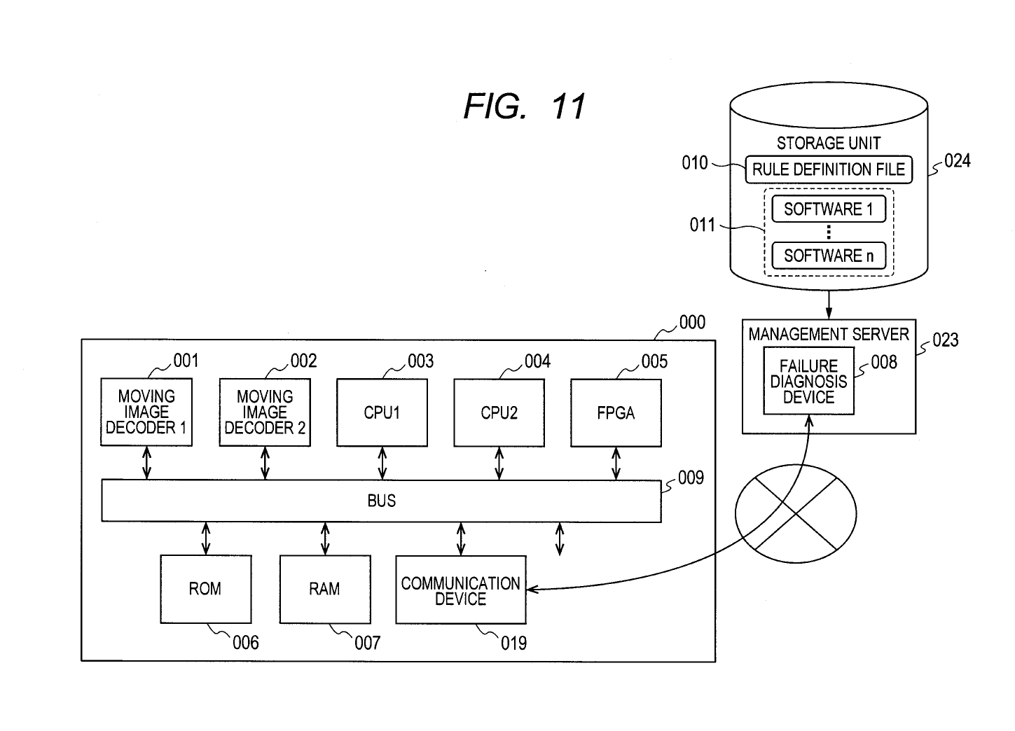

Next, an embedded system where a part of the function arranged in a network according to a fourth embodiment of the present invention will be described. FIG. 11 is a diagram illustrating a configuration of an embedded system according to a fourth embodiment of the present invention. The fourth embodiment and the first to third embodiments are different in configuration as follows. The embedded system of this embodiment includes a communication device 019 in a device main body 000, and is coupled to a management server 023 outside the device main body 000 and to a storage unit 024 through a network.

In the management server, the failure diagnosis device 008 has a function similar to those in the first to third embodiments. The rule definition file 010 has a similar configuration to the rule definition file in the first to third embodiment. The software group 011 has a similar configuration to the file group in the first to third embodiment.

In this embodiment, the communication device 019 delivers a monitoring signal received from the failure diagnosis device 008 to hardware units 001 to 005 of the device main body 000 that achieve functions. The communication device 019 receives a result signal returned from hardware units that achieve a function, thus delivering the failure diagnosis device 008 in a network. The management server 023 is a server for the failure diagnosis device 008 to perform.

The storage unit 024 in FIG. 11 may be included in the management server 023.

In this embodiment, the rule definition file 010 and the software group 011 are stored in the external storage unit 024. The function of the failure diagnosis device is placed in the management server 023. This allows the ROM 006 and the RAM 007 of the device main body 000 to have small capacity. This ensures cost reduction of the device main body.

### Fifth Embodiment

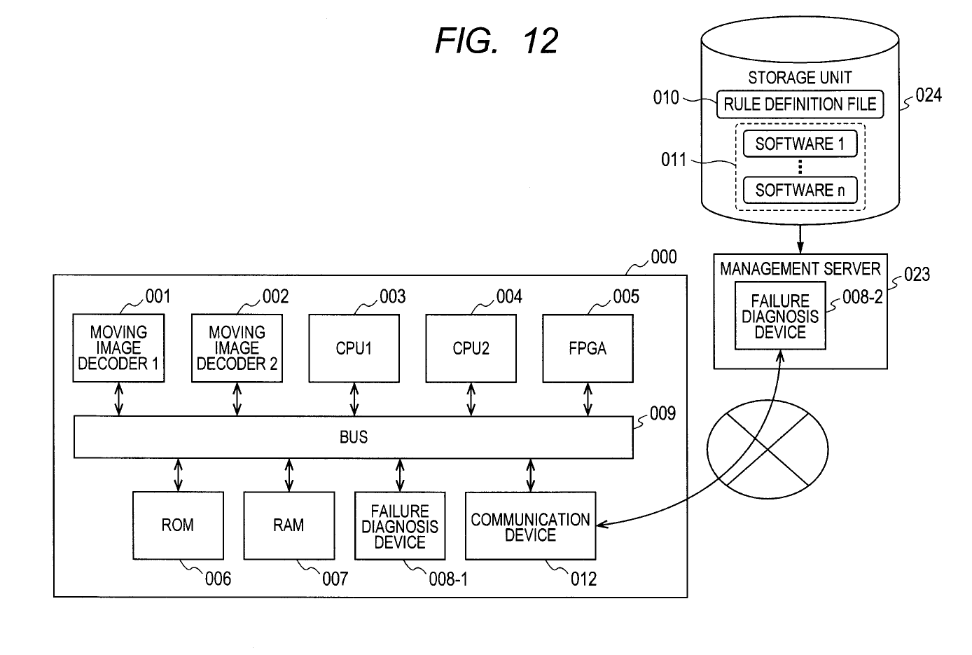

Next, an embedded system according to a fifth embodiment of the present invention will be described. FIG. 12 is a diagram illustrating a configuration of an embedded system according to the fifth embodiment of the present invention. The fifth embodiment is a modification of the fourth embodiment. That is, a part of the failure diagnosis device 008 is included both on the device main body 000 (008-1), which is a target to embed the present invention, and on the management server 023 (008-2) outside the device main body 000. The function of the failure diagnosis device 008 may be partially or completely moved outside depending on a use and a condition of use. For example, the processing target determiner 801, the monitoring signal generator 802, the signal transmitter and receiver 803, and the communication device 012, which are constituent elements of the failure diagnosis device 008 illustrated in FIG. 4 may be arranged in the failure diagnosis device 008-1 on the device main body 000. The failure determiner 804, the control processor 805, and the control process determiner, which are rest of the constituent elements, may be arranged in the failure diagnosis device 008-2 on the management server 023. Similarly to the fourth embodiment, the storage unit 024 in FIG. 12 may be included in the management server 023.

In this embodiment, the frequently-used diagnosis function and software group 011 are included in the device main body 000 (008-1) while the less frequently used functions and software group 011 are included in the network (008-2) outside the device main body 000. This ensures cost reduction of the device main body.

### (Modification)

The present invention is not limited to the above-described embodiments, and may be applied to other consumer electronics products and an industrial system including a CPU. For example, the present invention may be applied to a smart grid system to establish an intelligent power transmission network between an electric power provider and respective houses. An electric power meter for respective houses may be constituted of the embedded device and the embedded system of the present invention.

In the above embodiments of the present invention, a portion coupled to devices through a bus may not be the bus, and may be alternatively performed by another information transmitting means such as a network to exchange information.

The rule definition file 010 and the software group 011 in the device main body 000 or outside the device main body 000 may be upgraded through a network.

In the respective embodiments, the failure diagnosis device may be divided into a failure diagnosis unit and an alternative processing unit. Respective devices themselves may include the failure diagnosis unit that has a function of failure diagnosis. The device main body may include the alternative processing unit corresponding to respective devices. In this case, following configuration may be employed. In some devices, each device itself regularly performs failure diagnosis. If at least a part of the function fails, a notification is provided to the alternative processing unit. The alternative processing unit receives the notification and then selects a device that alternatively performs a function included in the failed device. The alternative processing unit executes an initiation of the alternative process. In this case, advantageous effects similar to the above-described embodiments are also provided.

### EXPLANATION OF REFERENCE SIGNS

001 first moving image decoder,
002 second moving image decoder,
003 first CPU,
004 second CPU,
005 FPGA,
006 ROM,
007 RAM,
008 failure diagnosis device,
009 bus,
010 rule definition file,
011 software group,
012 first moving image encoder,
013 second moving image encoder,
014 antenna,
017 television display screen,
018 external memory.

1. An embedded device comprising:
a plurality of hardware units, each of the hardware units achieving respective specific function;
a storage device; and
a failure diagnosis device configured to monitor functions of the respective hardware units, the failure diagnosis device executing an alternative process of a function when the hardware unit fails,
wherein the plurality of hardware units include:
at least one dedicated hardware unit configured to function specific function; and
at least one CPU configured to change a content of processing at application level,
wherein the storage device stores:
a rule definition file that defines one of the other hardware units when a failure is detected as an alternative processor of a function for the hardware unit where the failure is detected; and
a software group that is used to execute the alternative process of the function with the other hardware unit,
wherein the failure diagnosis device is configured to select the other hardware unit that alternatively performs the function of the hardware unit and the software required for the alternative process of the function by the other hardware unit based on the rule definition file and the software group if the failure of the function of one of the hardware units is detected.

2. The embedded device according to claim 1, wherein
the hardware units include a plurality of CPUs configured to function respective specific functions with respective dedicated software programs,
the failure diagnosis device is configured to select any of the CPUs that performs an alternative function of the dedicated hardware unit if the failure of the function is detected in the dedicated hardware unit, the failure diagnosis device executing a software required for the alternative process of the function for the dedicated hardware unit where the failure is detected, using the selected CPU.

3. The embedded device according to claim 1, wherein
the hardware units include multiple cores that achieve respective specific functions with respective dedicated software programs, wherein
the failure diagnosis device is configured to select any core among the multiple cores that performs the alternative function of the dedicated hardware unit if the failure of the function is detected in the dedicated hardware unit, the failure diagnosis device executing a software required for the alternative process of the function for the dedicated hardware unit where the failure is detected, using the selected core.

4. The embedded device according to claim 1, wherein
the rule definition file includes information relating to alternative priority when the hardware unit fails for each of the hardware units, with respect to a plurality of other hardware units that alternatively perform functions of the hardware unit, and the software programs required for the alternative process of the function for the other hardware unit.

5. The embedded device according to claim 1, wherein
the rule definition file includes attribution of a target device, a monitoring method, an alternative device, an alternative order, and alternative software information,
the target device registers each name of the hardware unit that is a monitoring target of the embedded device, and
the monitoring method registers a determining unit configured to determine a function for the hardware unit and an interface configured to call and execute the determining unit.

6. The embedded device according to claim 5, wherein
the rule definition file includes attribution of the alternative device and the alternative order,
the alternative device registers a name of hardware unit that is able to alternatively perform the function of the target device or a name of hardware unit that is desired to alternatively perform the function of the target device, and
the alternative order registers a content of priority for each of the target devices, the content of priority being indicative of hardware units to alternatively perform on a priority basis when the target device fails among the hardware units registered in the alternative device.

7. The embedded device according to claim 6, wherein
the rule definition file includes attribution of alternative software information, and
the alternative software information registers the software group to execute on the alternative device for alternation when the function is alternatively performed.

8. The embedded device according to claim 1, wherein
the failure diagnosis device is achieved with one software program or a plurality of software programs that are implemented in the CPU.

9. The embedded device according to claim 1, wherein
the hardware unit includes a first dedicated hardware unit and a second dedicated hardware unit, the first dedicated hardware unit achieving the specific function, the second dedicated hardware unit being different from the first dedicated hardware unit in specification, the second dedicated hardware unit being able to achieve a similar function to the function of the first dedicated hardware unit, and
an alternative function of the dedicated hardware unit is alternatively performed by another dedicated hardware unit or the CPU when a failure of a function is detected in one of the first and second dedicated hardware units.

10. The embedded device according to claim 9, wherein
the hardware unit includes an FPGA that is able to change a content of processing, and
an alternative function of the dedicated hardware unit is alternatively performed by another dedicated hardware unit, the CPU, or the FPGA when the failure of the function is detected in one of the first and second dedicated hardware units.

11. The embedded device according to claim 9, wherein
the hardware unit includes a first moving image decoder and a second moving image decoder, the first moving image decoder and the second moving image decoder having a same function and different specification, wherein
an alternative function of the moving image decoder is alternatively performed by another moving image decoder or the CPU when the failure of the function is detected in one of the first and second moving image decoders.

12. The embedded device according to claim 1, wherein
the embedded device includes a main body that is a digital television receiver, wherein
the hardware unit includes:
a first moving image decoder that has a main function of decoding configured to display a broadcast program;
a second moving image decoder that has a main function of decoding configured to display a broadcast program and playback of a recorded program;
a first CPU that has a main function of processing for Internet contents and the like;
a second CPU that has a main function of processing for user interface; and
an FPGA that has a main function of processing for high image quality, wherein
the failure diagnosis device is configured to select one of the first CPU and the second CPU, the failure diagnosis device selecting the software required for an alternative process of the function with the selected CPU based on the rule definition file and the software group so as to alternatively perform the function of the first moving image decoder or the second moving image decoder when a failure is detected in one of the first moving image decoder and the second moving image decoder.

13. The embedded device according to claim 1, wherein
the embedded device includes a main body that is a mobile phone, wherein
the hardware unit includes:
a first moving image decoder that has a main function of decoding configured to display a photograph and a still image;
a second moving image decoder that has a main function of decoding configured to display a One-Seg broadcast program and playback of a recorded program and the like;
a first core of multiple cores that has a main function of processing configured to perform a phone call;
a second core of multiple cores that has a main function of multimedia process; and
an FPGA that has a main function for high image quality, wherein
the failure diagnosis device is configured to select one of the first core and the second core of the multiple cores, the failure diagnosis device selecting the software required for an alternative process of the function with the selected core based on the rule definition file and the software group so as to alternatively perform the function of the first moving image decoder or the second moving image decoder when a failure is detected in one of the first moving image decoder and the second moving image decoder.

14. The embedded device according to claim 1, wherein
the embedded device includes a main body that is a car navigation system, wherein
the hardware unit includes:
a moving image decoder that has a main function of a navigation function; and
a CPU or a core that has a main function corresponding to music or a phone call, wherein
the failure diagnosis device is configured to select one of the CPU and the core, the failure diagnosis device selecting the software required for an alternative process of the function with the selected CPU or core, so as to alternatively perform the function of the moving image decoder based on the rule definition file and the software group when a failure is detected in the moving image decoder.

15. An embedded system comprising:
a device main body that includes a plurality of hardware units, each of the hardware units achieving respective specific functions;
a failure diagnosis device configured to monitor functions of the respective hardware units, the failure diagnosis device performing an alternative process of a function when each of the hardware units fails;
an external management server and a storage device that are coupled to the device main body through a network;
a communicator configured to communicate the device main body with the external management server and the storage device;
a rule definition file that defines any of other hardware units when a failure is detected as an alternative processor of a function for a hardware unit where the failure is detected; and
a software group that is used to execute the alternative process of the function with the other hardware unit, wherein the plurality of hardware units include:
at least one dedicated hardware unit that achieves a specific function; and
at least one CPU that can change a content of processing at application level, wherein
the rule definition file and the software group are stored in one of the management server and the storage device, wherein
the failure diagnosis device is configured to select another hardware unit that alternatively performs a function of the hardware unit and the software required for an alternative process of the function by the other hardware unit based on the rule definition file and the software group when a failure of a function of one of the hardware units is detected.

16. The embedded system according to claim 15, wherein
the failure diagnosis device is stored in the management server.

17. The embedded system according to claim 15, wherein
the failure diagnosis device is divided and each embedded in both of the main body of the embedded system and the management server.

18. The embedded system according to claim 15, wherein
the hardware unit includes a CPU or multiple cores that achieve respective specific functions with respective dedicated software programs, wherein
the failure diagnosis device is configured to select one of the CPU and one core of the multiple cores that alternatively performs a function of the dedicated hardware unit when the failure of the function is detected in the dedicated hardware unit, the failure diagnosis device executing a software program required for the alternative process of the function for the dedicated hardware unit where the failure is detected, using the selected CPU or core.

19. An embedded device comprising:
a plurality of hardware units, the hardware units achieving respective specific functions;
a storage device;
a failure diagnosis device configured to monitor functions of the respective hardware units; and
an alternative processing unit configured to execute an alternative process of a function when the hardware unit fails, wherein
the plurality of hardware unit includes at least one dedicated hardware unit that achieves a specific function and at least one CPU that can change a content of processing at application level,
the storage device stores a rule definition file and a software group, when a failure is detected, the rule definition file defining any one of the other hardware units as an alternative processor of a function for a hardware unit where the failure is detected, the software group being used to execute the alternative process of the function with the other hardware unit,
each of the hardware units itself regularly performs failure diagnosis, each of the hardware units provides a notification to the alternative processing unit when the failure occurs in a function of at least a part of the hardware unit, and
the alternative processing unit is configured to select another hardware unit that alternatively performs a function of the hardware unit and the software required for an alternative process of the function by the other hardware unit based on the rule definition file and the software group when the failure of the function of one of the hardware units is detected by the failure diagnosis device.

20. The embedded device according to claim 19, wherein
the rule definition file includes information relating to alternative priority when the hardware unit fails for each of the hardware units, with respect to: a plurality of other hardware units that alternatively perform functions of the hardware unit, and the software programs required for the alternative process of the function for the other hardware unit.
